(19) United States
(12) Patent Application Publication
(10) Pub. No.: US 2021/0003061 A1
(43) Pub. Date: Jan. 7, 2021

(54) MULTI-LAYER EXHAUST INSULATION SYSTEM AND METHOD

(71) Applicants: John Merrett, Lincoln, NE (US); John Jarecki, Lincoln, NE (US); Jeremy Miller, Seward, NE (US); Adam Matzer, Lincoln, NE (US)

(72) Inventors: John Merrett, Lincoln, NE (US); John Jarecki, Lincoln, NE (US); Jeremy Miller, Seward, NE (US); Adam Matzer, Lincoln, NE (US)

(21) Appl. No.: 16/917,485

(22) Filed: Jun. 30, 2020

Related U.S. Application Data
(60) Provisional application No. 62/869,443, filed on Jul. 1, 2019.

(51) Int. Cl. F01N 13/14; B32B 5/02; B32B 5/12; B32B 5/26; B32B 27/12; B32B 27/28

(52) U.S. Cl. CPC F01N 13/148; B32B 5/024; B32B 5/12; B32B 5/26; B32B 2307/304; B32B 27/281; B32B 2260/021; B32B 2260/046; B32B 2262/101; B32B 27/12

(57) ABSTRACT

An exhaust insulation system and associate methods are described that include multiple layers. In one example, a system includes a base insulation layer, a polyimide layer at least partially surrounding the base insulation layer, and an outer fabric layer, wherein the fabric is impregnated with a resin.

### RELATED APPLICATION

This application claims priority to U.S. Provisional Patent Application No. 62/869,443, entitled “MULTI-LAYER EXHAUST SYSTEM AND METHOD,” filed on Jul. 1, 2019, which is incorporated herein by reference in its entirety.

### TECHNICAL FIELD

Various embodiments described herein relate to insulation systems. One specific example includes exhaust pipe insulation systems.

### BACKGROUND

Insulation systems can be used to retain heat or cold within an enclosure. Insulation systems can also be used for safety to protect users from a hot region of equipment. In selected insulation systems, multiple material layers are used, wherein each layer serves a different purpose. Improved exhaust insulation systems are desired.

### BRIEF DESCRIPTION OF THE DRAWINGS

FIG. 1A shows an exhaust insulation system according to an embodiment of the invention.

FIG. 1B shows another exhaust insulation system according to an embodiment of the invention.

FIG. 2 shows a portion of a braided fiber material layer according to an embodiment of the invention.

FIG. 3 shows a portion of a fiber mat insulation layer according to an embodiment of the invention.

FIG. 4 shows a portion of a knit material layer according to an embodiment of the invention.

FIG. 5 shows a portion of a braided sleeve layer according to an embodiment of the invention.

FIG. 6 shows a flow diagram of a method of insulating an exhaust pipe according to an embodiment of the invention.

### DETAILED DESCRIPTION

In the following detailed description of the invention, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized and structural, logical, and electrical changes may be made.

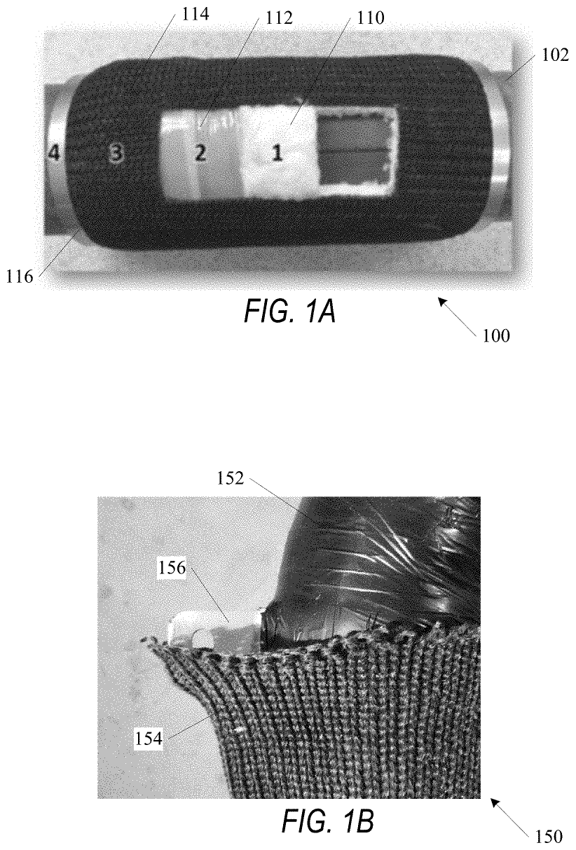

FIG. 1A shows an example of an exhaust insulation system 100. The system 100 is shown over a workpiece 102. In the example of FIG. 1, the workpiece 102 includes an exhaust component, although the invention is not so limited. More specifically, the workpiece 102 in FIG. 1, illustrates a section of an exhaust pipe. In selected examples, the exhaust insulation system 100 is implemented to cover a portion of an exhaust pipe to prevent adjacent components from undue heat exposure, or to reduce risk of injury to an operator, by shielding the portion of exhaust pipe. Other exhaust components that may be insulated using examples of the present invention include, but are not limited to, mufflers, manifolds, catalytic converters, etc. Although exhaust components are used as an example, insulation systems described in the present disclosure may be used to insulate any hot or cold component from unwanted external exposure.

The exhaust insulation system 100 includes a base insulation layer 110. In one example, the base insulation layer 110 includes a fiber mat insulation layer. The base insulation layer 110 shown in FIG. 1A illustrates a fiber mat insulation layer. In one example the fiber mat insulation layer includes substantially random fiber orientations within a plane of the mat. In one example the fiber mat insulation layer includes E-glass fibers. One advantage of fiber mat insulation layers includes additional space for trapped air, which increases an insulating property of the fiber mat insulation layer. Another advantage of a fiber mat insulation layer is cost. Fiber mat insulation layers are significantly less expensive than fabric insulation, which reduces an overall cost of the system 100. In one example using a fiber mat insulation layer as a base insulation layer 110, a thickness dimension is controlled, and installation is simplified as described below.

In one example, the fiber mat insulation layer 110 includes a glass fiber mat. Glass fiber mats have an advantage of being less expensive than ceramic fiber mats or other high temperature fiber mats. In selected examples the performance of other fiber materials provides advantages that justify the increased cost over glass fiber mats.

The fiber mat insulation layer 110 may, for example, be formed from a fiber mat such as a vitreous silicate fiber mat, a ceramic fiber mat or a high-temperature (HT) ceramic fiber mat. In one example, a combination of fiber types may be included in the fiber mat insulation layer 110. The type of mat may be selected based on performance characteristics. The chart below illustrates thermal conductivity versus temperature for three different fiber mats.

A vitreous silicate mat does not form Crystobalite, is bio-soluble and has low irritability when handling. Crystobalite is undesirable in some circumstances due to health concerns. It is also less expensive that ceramic fiber mat and has low shot content. Shot content (the amount of non-fiber particles found in a mat) may be undesirable because non-fiber particles do not trap insulating air as effectively as fibers. Ceramic fibers are more expensive than vitreous silicate but offer insulation up to higher peak and service temperatures. In one example, ceramic fibers have a high melt temperature (>3000° Fahrenheit). Ceramic fiber mats can also provide low heat storage and better sound absorption than a vitreous silicate mat, making it preferred in some installation environments. Ceramic fiber mats can also be free of binder or lubricant and be immune to thermal shock.

In one example, the fiber matt insulation layer includes one or more types of high temperature insulating wool fibers. Examples include, but are not limited to, alkaline earth silicate wool (AES wool), aluminum silicate wool (ASW), refractory ceramic fiber (RCF), and polycrystalline wool (PCW).

In one example, the base insulation layer 110 includes a braided fiber fabric insulation layer, such as a braided glass fabric insulation layer. A braided fabric includes a number of fibers or yarns that are interwoven without yarns being twisted about one another. In one example, a braided base insulation layer 110 includes a bi-axial braided base insulation layer 110. In one example, a braided base insulation layer 110 includes a bi-axial braided sleeve. One advantage of a braided sleeve includes the ability to conform to the workpiece 102 over a large range of diameters. For example, by axially compressing or stretching a braided sleeve, an inner diameter of the braided sleeve may vary by as much as 50 percent.

Additionally, braided sleeves are dimensionally consistent. Once a braided sleeve is installed over a workpiece 102, and an inner diameter is tightened by stretching, there is minimal variation in a thickness of the braided sleeve. If subsequent layers of the system 100 are desired, it is easier to slide them over the base insulation layer 110 if the thickness dimension is consistent. Further, once a braided sleeve is installed, it tends to stay in place, making subsequent layers easier to install. After stretching a braided sleeve, the braided sleeve will tend to grip the workpiece, keeping the braided sleeve in place. A drawback is that a braided glass does not compress once fitted over a component, tends to cost significantly more than mat insulation and can have poorer performance in certain applications.

FIG. 1A further shows a polyimide layer 112 at least partially surrounding the base insulation layer 110. In one example, as can be seen in FIG. 1A, the polyimide layer 112 includes a band of polyimide wrapped spirally around the fiber mat insulation layer 110. In one example, the process of wrapping the fiber mat insulation layer 110 at least partially compresses the fiber mat insulation layer 110. In this way, a thickness of the fiber mat insulation layer 110 is more effectively controlled than with a bare fiber mat insulation layer 110. For example, fiber mat insulation base layer 110 may be compressed by about 40%-60% or more, depending on the application. In one example, the fiber mat insulation layer 110 has a thickness of about 0.75 inches when placed over an exhaust component and a thickness of 0.40 inches after being compressively wrapped by the polyimide layer.

Additionally, by wrapping the fiber mat insulation layer 110, later processing steps in forming the system 100 are facilitated because, for example, the fiber mat insulation layer 110 is held firmly in place by the polyimide layer 112 and the polyimide layer provides a smooth surface and firm base for an outer fabric layer. Although polyimide is shown in FIG. 1A, other materials such as other polymers, or foil materials may also be used within the scope of the invention. Polyimide can provide advantages in certain application over foil material by, for example, moisture resistance, its ease of installation by wrapping, its resistance to automotive chemicals, and its low cost.

FIG. 1A further shows an outer fabric layer 114. In one example the outer fabric layer 114 is impregnated with a resin. In one example, the resin includes a thermoset resin. In one example, the thermoset resin includes an epoxy resin. In one example, the thermoset resin includes a cured phenolic resin. One advantage of phenolic resin includes desirable cure conditions such as cure temperature, and storage lifetime prior to cure. Another advantage of phenolic resin includes low cost, and desirable high temperature properties after cure. A thermoset resin includes properties, in contrast to a thermoplastic resin. Thermoplastic resin (and thermoplastic polymers) are meltable, and can be cycled between a flowable state and a solid or glass like state. In contrast to thermoplastics, thermosets, once cured, cannot be melted. As a result, thermosets provide improved high temperature stability. Thermosets are not susceptible to unwanted melting under high temperature conditions.

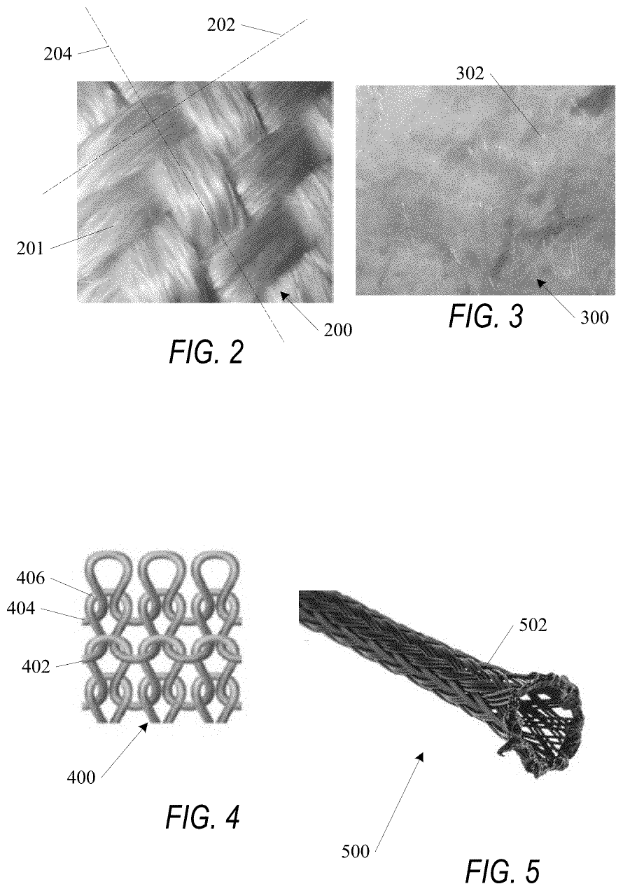

In one example, the fabric includes glass fibers that form the fabric. In one example, the glass fibers include E-glass. In one example the outer fabric layer 114 includes a braided glass fiber fabric. In one example the outer fabric layer 114 includes a bi-axially braided glass fiber fabric. In one example the outer fabric layer 114 includes a knitted glass fiber fabric. A phenolic, thermosetting resin-impregnated braid is illustrated in FIG. 1A. The braid is made from multiple raw glass woven strands, each of the same type. Example fabric weaves that may be used for the outer fabric layer 114 are illustrated in more detail in FIGS. 2, 4 and 5. Although a number of examples are listed, the invention is not so limited. Other resins and other fabric weaves and fabric materials are also within the scope of the invention.

FIG. 1A further shows one or more retaining bands 116 located on one or more ends of an insulated portion. Although not required, retaining bands 116 may be useful to hold the system 100 in place during a cure step. Retaining bands 116 may also be useful to enclose rough edges of a layer, such as outer fabric layer 114, and to provide an aesthetically pleasing transition from an insulated portion to an un-insulate portion.

FIG. 1B shows another example of an exhaust insulation system 150. In the example of FIG. 1B, a polyimide layer 152 is shown covering a base insulation layer (not visible in FIG. 1B) similar to base layers 110 described in FIG. 1A. As in the example of FIG. 1A, example base insulation layers include fiber mat insulation, with several possible fiber types. In one example, the fiber mat insulation used in FIG. 1B includes a high temperature insulating fiber, such as a mat including ceramic fibers. The polyimide layer 152 illustrated in FIG. 1B is black in color, in contrast to the orange-brown color of the polyimide 112 in FIG. 1A. Any color of polyimide may be used for layer 152.

A mount 156 is shown coupled to the workpiece. As discussed in examples above, in one example, the workpiece is an exhaust pipe component, although the invention is not so limited. An outer fabric layer 154 is further shown in FIG. 1B. In one example, the outer fabric layer 153 includes a knit fabric weave. In the example of FIG. 1B, the knit fabric weave is capable of additional stretching and contraction over features such as the mount 156. This property is advantageous over other weaves such as a braided weave that may not be capable of the range of expansion and contraction of a knit weave as shown. In one example, the knit weave is impregnated with a resin as discussed in examples above. In one example, the resin includes a thermoset resin. In one example, the thermoset resin includes an epoxy resin. In one example, the thermoset resin includes a cured phenolic resin. In one example, a knit weave is uniquely capable of stretching over a mount 156, then contracting in place over an exhaust pipe, and subsequently being cured with a highly smooth surface finish as shown in FIG. 1B.

FIG. 2 shows an example of a bi-axial braided weave 200 of glass fibers. A first axis 202 and a second axis 204 indicate the two axes of the bi-axial weave. In contrast to a knitted weave, fibers 201 of braided weave 200 shown in FIG. 2 are not twisted around one another, and are instead held together by overlapping. Braided weaves can provide high strength in composite structures in the direction of one or more axes (202, 204) because the fibers are not significantly bent. Fibers typically have higher strength along their axes, compared to fibers with bends or twists.

FIG. 3 shows an example of a fiber mat 300 of glass fibers 302. As illustrated in the Figure, the fibers 302 have a substantially random fiber orientation within a plane of the mat. As noted above, one advantage of fiber mat 300 insulation layers includes additional space for trapped air, which increases an insulating property of the fiber mat insulation layer. Another advantage of a fiber mat 300 insulation layer is cost.

FIG. 4 shows an example of a knit fiber weave 400. In contrast to the braided weave 200 from FIG. 2, the knit fiber weave 400 includes looped fibers. For example, first fiber 402 is shown looped around second fiber 404 with loop 406. Knit weaves can provide greater flexibility than braided weaves that may be useful in covering complex shapes, or in negotiating large bends in a workpiece.

In one example, a knit weave fabric is used as an outer fabric layer 114 as illustrated in FIG. 1B, and provides ease of installation over other components such as the fiber mat insulation layer 110 and the polyimide layer 112 due to the higher flexibility of knit weaves. In one example, a knit weave is more easily tightened around the fiber mat insulation layer 110 and the polyimide layer 112, and any underlying metal formations in an exhaust system. Ease of tightening provide better conforming of the outer fabric layer 112 over protrusions such as weld joints, mechanical couplings, etc. Knit weaves further provide a smoother final surface finish, which is aesthetically pleasing, and less abrasive to an end user.

FIG. 5 shows an example of a sleeve 500. In the example shown, the sleeve 500 is a braided sleeve. Individual fibers 502 are generally not bent in tight twists, although the individual fibers 502 of sleeve 500 do generally spiral around the sleeve 500 in a wide arc. The relative straightness of fibers 502 without significant loops, as compared to loop 406 from knit weave 400, provides higher strength to sleeve 500.

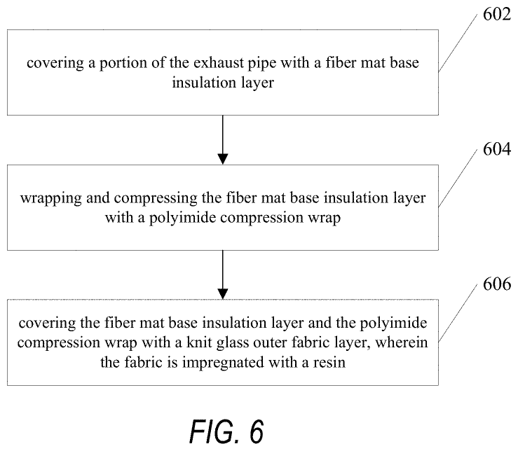

FIG. 6 shows a flow diagram of an example method of insulating an exhaust pipe. In operation 602, a portion of an exhaust pipe is covered with a fiber mat base insulation layer (e.g., vitreous silicate mat, ceramic fiber mat, other fibers, or combinations of fibers). In operation 604, the base insulation layer is wrapped and compressed with a compression wrap (e.g., a polyimide film, foil film, etc.). In operation 606, the inner fiber mat insulation layer and the compression wrap is covered with an outer fabric layer, wherein the fabric is impregnated with a resin. In selected examples, the resin is later cured to harden the outer fabric layer. For example, a raw glass braid outer fabric layer is first dipped in a phenolic resin and allowed to semi-cure. The semi-cured braid is then placed over an exhaust part (already wrapped with a polyimide film over a fiber mat base layer) and thereafter given a final cure at an elevated temperature to harden the outer fabric layer and form a composite cover for the exhaust insulation system. In some examples, after cooling, the hardened cover is secured to the exhaust part with high strength stainless steel bands on both ends.

To better illustrate the method and apparatuses disclosed herein, a non-limiting list of embodiments is provided here:

Example 1 includes an exhaust insulation system. The system includes a base insulation layer, a polyimide layer at least partially surrounding the base insulation layer, and a braided glass outer fabric layer, wherein the fabric is impregnated with a resin.

Example 2 includes the exhaust insulation system of example 1, wherein the base insulation layer includes a fiber mat insulation layer having substantially random fiber orientations within a plane of the mat.

Example 3 includes the exhaust insulation system of any one of examples 1-2, wherein the middle layer includes a band of polyimide wrapped spirally around the fiber mat insulation layer.

Example 4 includes the exhaust insulation system of any one of examples 1-3, wherein the band of polyimide compresses the fiber mat insulation layer against an exhaust pipe.

Example 5 includes the exhaust insulation system of any one of examples 1-4, wherein the band of polyimide compresses the fiber mat insulation layer within a range of about 40 percent to about 60 percent from an uncompressed state.

Example 6 includes the exhaust insulation system of any one of examples 1-5, wherein the band of polyimide compresses the fiber mat insulation layer to about 0.45 inches from an uncompressed thickness of about 0.75 inches.

Example 7 includes the exhaust insulation system of any one of examples 1-6, wherein the band of polyimide compresses the fiber mat insulation layer to about 0.60 inches from an uncompressed thickness of about 1.00 inches.

Example 8 includes the exhaust insulation system of any one of examples 1-7, wherein the braided glass outer fabric layer is impregnated with a thermoset resin.

Example 9 includes the exhaust insulation system of any one of examples 1-8, wherein the braided glass outer fabric layer is impregnated with a phenolic thermoset resin.

Example 10 includes the exhaust insulation system of any one of examples 1-9, further including retaining bands on ends of the outer fabric layer to clamp the exhaust insulation system to an exhaust pipe.

Example 11 includes the exhaust insulation system of any one of examples 1-10, wherein the braided glass outer fabric layer includes a biaxially braided glass fiber fabric.

Example 12 is an exhaust insulation system. The exhaust insulation system includes a base insulation layer, a polyimide compression layer at least partially surrounding the base insulation layer, and a knit outer fabric layer, wherein the fabric is impregnated with a resin.

Example 13 includes the exhaust insulation system of example 12, wherein the base insulation layer includes a fiber mat insulation layer having substantially random fiber orientations within a plane of the mat.

Example 14 includes the exhaust insulation system of any one of examples 12-13, wherein the polyimide compression layer includes a spiral band of polyimide wrapped around the base insulation layer.

Example 15 includes the exhaust insulation system of any one of examples 12-14, wherein the polyimide compression layer reduces a thickness of the base insulation layer by about 40% to about 60% from an uncompressed state.

Example 16 includes the exhaust insulation system of any one of examples 12-15, wherein the knit outer fabric layer is impregnated with a phenolic thermoset resin.

Example 17 includes a method of insulating an exhaust pipe. The method includes covering a portion of the exhaust pipe with a fiber mat base insulation layer, wrapping and compressing the fiber mat base insulation layer with a polyimide compression wrap, and covering the fiber mat base insulation layer and the compression wrap with a knit glass outer fabric layer, wherein the fabric is impregnated with a resin.

Example 18 includes the method of example 17, wherein wrapping and compressing the fiber mat base insulation layer with the polyimide compression wrap includes wrapping and compressing the fiber mat base insulation layer with a spiral band of polyimide compression wrap.

Example 19 includes the method of any one of examples 17-18, further including curing a thermoset resin impregnated in the outer fabric layer.

Example 20 includes the method of any one of examples 17-19, wherein curing the thermoset resin impregnated in the outer fabric layer includes curing a phenolic resin.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An exhaust insulation system, comprising:
a base insulation layer;
a middle polyimide layer at least partially surrounding the base insulation layer; and
a braided glass outer fabric layer, wherein the fabric is impregnated with a resin.

2. The exhaust insulation system of claim 1, wherein the base insulation layer includes a fiber mat insulation layer having substantially random fiber orientations within a plane of the mat.

3. The exhaust insulation system of claim 1, wherein the middle layer includes a band of polyimide wrapped spirally around the fiber mat insulation layer.

4. The exhaust insulation system of claim 3, wherein the band of polyimide compresses the fiber mat insulation layer against an exhaust pipe.

5. The exhaust insulation system of claim 4, wherein the band of polyimide compresses the fiber mat insulation layer within a range of about 40 percent to about 60 percent from an uncompressed state.

6. The exhaust insulation system of claim 4, wherein the band of polyimide compresses the fiber mat insulation layer to about 0.45 inches from an uncompressed thickness of about 0.75 inches.

7. The exhaust insulation system of claim 4, wherein the band of polyimide compresses the fiber mat insulation layer to about 0.60 inches from an uncompressed thickness of about 1.00 inches.

8. The exhaust insulation system of claim 1, wherein the braided glass outer fabric layer is impregnated with a thermoset resin.

9. The exhaust insulation system of claim 8, wherein the braided glass outer fabric layer is impregnated with a phenolic thermoset resin.

10. The exhaust insulation system of claim 1, further including retaining bands on ends of the outer fabric layer to clamp the exhaust insulation system to an exhaust pipe.

11. The exhaust insulation system of claim 1, wherein the braided glass outer fabric layer includes a biaxially braided glass fiber fabric.

12. An exhaust insulation system, comprising:
a base insulation layer;
a polyimide compression layer at least partially surrounding the base insulation layer; and
a knit outer fabric layer, wherein the fabric is impregnated with a resin.

13. The exhaust insulation system of claim 12, wherein the base insulation layer includes a fiber mat insulation layer having substantially random fiber orientations within a plane of the mat.

14. The exhaust insulation system of claim 13, wherein the polyimide compression layer includes a spiral band of polyimide wrapped around the base insulation layer.

15. The exhaust insulation system of claim 14, wherein the polyimide compression layer reduces a thickness of the base insulation layer by about 40% to about 60% from an uncompressed state.

16. The exhaust insulation system of claim 15, wherein the knit outer fabric layer is impregnated with a phenolic thermoset resin.

17. A method of insulating an exhaust pipe, comprising:
covering a portion of the exhaust pipe with a fiber mat base insulation layer;
wrapping and compressing the fiber mat base insulation layer with a polyimide compression wrap; and
covering the fiber mat base insulation layer and the polyimide compression wrap with a knit glass outer fabric layer, wherein the fabric is impregnated with a resin.

18. The method of claim 17, wherein wrapping and compressing the fiber mat base insulation layer with the polyimide compression wrap includes wrapping and compressing the fiber mat base insulation layer with a spiral band of polyimide compression wrap.

19. The method of claim 17, further including curing a thermoset resin impregnated in the outer fabric layer.

20. The method of claim 19, wherein curing the thermoset resin impregnated in the outer fabric layer includes curing a phenolic resin.
